(19) United States
(12) Patent Application Publication
(10) Pub. No.: US 2025/0313117 A1
(43) Pub. Date: Oct. 9, 2025

(54) SYSTEM FOR REMOVING BATTERY FROM COMPACT LOADER

(71) Applicant: The Charles Machine Works, Inc., Perry, OK (US)

(72) Inventors: Mark W. Kiner, Perry, OK (US); Brant D. Kukuk, Perry, OK (US); Dustin L. Blessum, Edmond, OK (US); D. Dylan Misener, Stillwater, OK (US); Micah C. Busboom, Stillwater, OK (US)

(21) Appl. No.: 19/172,170

(22) Filed: Apr. 7, 2025

Related U.S. Application Data
(60) Provisional application No. 63/575,901, filed on Apr. 8, 2024.
(60) Provisional application No. 63/747,559, filed on Jan. 21, 2025.

(51) Int. Cl. B60L 53/80; B60L 50/60; B60L 58/10; E02F 9/20

(52) U.S. Cl. CPC B60L 53/80; B60L 50/60; B60L 58/10; E02F 9/2091; B60L 2200/40

(57) ABSTRACT

A system for disconnecting and connecting batteries on a work machine. The work machine has a prime battery, which may be supported by a specialized subframe on the frame of the work machine. The subframe has a cammed lever which provides ease of connection and disconnection of the prime battery. Once the prime battery is disconnected, an auxiliary battery operates the work machine in “limp mode”, or a reduced power setting, so that the prime battery can be placed for recharging. The auxiliary battery powers a system, which may be a stowed crane, a set of slides, or other mechanism, which removes the battery from the frame and places it away from the work machine, at a charging station or other location. A new, fully charged prime battery may then be placed into the subframe by the system, and connected through operation of the cammed lever.

### SUMMARY

The present invention is directed to a work machine. The work machine comprises a frame, a ground engaging member providing mobility to the frame, lift arms, a first battery, a second battery, and a battery removal system. The lift arms are attached to the frame. The first battery is supported by the frame and provides power to the ground engaging member and the lift arms. The second battery is supported by the frame and provides power to the ground engaging member and the lift arms. The battery removal system is powered by the second battery and configured to remove the first battery from the frame.

In another aspect the invention is directed to a method for operating a battery-powered work machine. The method comprises the steps of powering operation of the work machine with a first battery. The operation of the work machine includes movement of the work machine at a work site. The method further comprises monitoring a power level of the first battery to determine if it is below a predetermined threshold, and when the power level is below the predetermined threshold, rotating a cammed lever on the frame to disconnect the first battery from the work machine. Thereafter, with the second battery, the method includes moving the work machine to a battery charging location, placing the first battery at the battery charging location, and retrieving a fully-charged third battery. The third battery is then connected to the work machine.

In another aspect the invention is directed to a method. The method comprises operating a work machine with a first battery in a high-power mode, when a power level of the first battery reaches a predetermined level, operating the work machine with a second battery in a low-power mode, and with the second battery, operating the work machine to remove the first battery to a charging location.

### BRIEF DESCRIPTION OF THE DRAWINGS

FIG. 1 is a side view of a compact loader with a system for offloading a prime battery. An auxiliary battery is shown in phantom. The compact loader's arms are partially raised, and the system for offloading the battery is a slide system attached to the loader's frame.

FIG. 2 is a front right top view of a compact loader's frame. Tracks, lift arms, and other components are removed for clarity. A subframe is visible within the frame itself. In FIG. 2, the system for offloading the prime battery is a crane.

FIG. 3 is front right top view of a subframe with a cammed lever for use with a battery.

FIG. 4 is a back left view of a prime battery, with a connection point shown. Cleats on the bottom of the battery are capable of mating with structures on the subframe to hold the battery in place.

FIG. 5 is a view of the connection point on the battery shown in FIG. 4.

FIG. 6 is a connector located on the frame of the compact loader, capable of connection to the connection point in FIG. 5.

FIG. 7 is a view of the crane shown in FIG. 2.

FIG. 8 is a compact loader carrying a battery to a charging location. The compact loader is powered by the auxiliary battery in FIG. 8, and carrying the prime battery with its lift arm.

FIG. 9 is an alternative embodiment, with slides disposed on the lift arms, such that the slides may be attached to the prime battery for removal and replacement thereof.

FIG. 10 is a side view thereof, with the battery moved away from the frame of the compact loader.

FIG. 11 is a side view thereof, with the prime battery placed into a charging location.

### DETAILED DESCRIPTION

As vehicles, including work and jobsite vehicles, are moving to electric power using an on-site battery, practical problems associated with battery life move to the forefront of an operator's decision-making. For example, many work vehicles, such as the ride-on compact utility loaders shown in the appended figures, require a high load to operate. Even heavy-duty, purpose-built batteries may have a life numbering in the hours. To maximize the amount of time between battery replacements, large batteries are often used. Large batteries, however, are quite heavy. Thus, other equipment is often required to offload the batteries from the vehicle.

In order to keep electric vehicles from becoming stranded away from such equipment, many batteries are capable of a “limp mode.” In a “limp mode”, the battery will operate at a low power—for example, enough power to operate tracks and move the machine at a low speed, but not enough for any work operations. The vehicle can then be piloted to other equipment (for example, an overhead crane or other loading equipment) where the battery can be removed and replaced using those resources.

Sensors are often used to detect when a battery's charge levels are low, requiring a low-power “limp mode” rather than a high power operational mode. In the present invention, it should be understood that after reaching a certain threshold power limit, which may be predetermined, the compact loader 10 may indicate that a low power condition is detected in the primary battery. As a result of this detection, the machine may be operated to remove the primary battery. However, a secondary battery, which may be smaller, is capable of “limp mode” operations which include the system for battery replacement discussed herein.

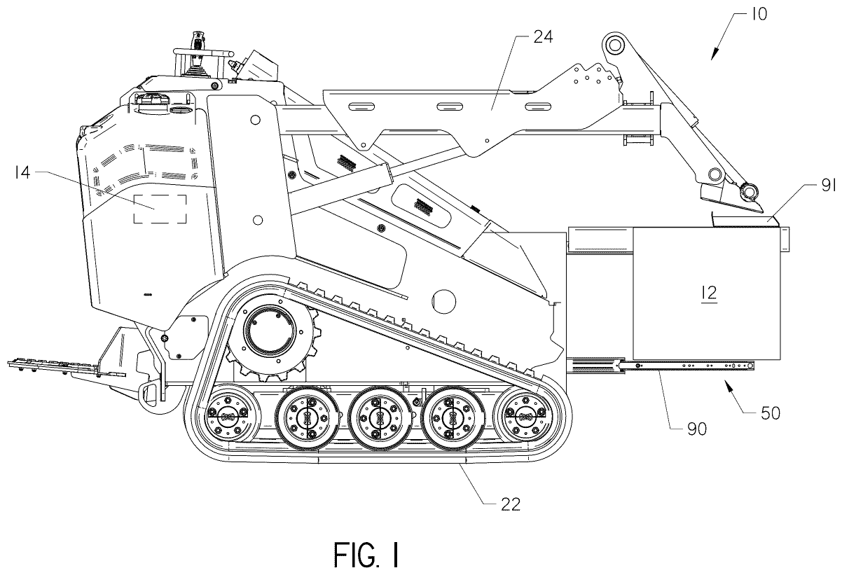

Turning now to the figures, FIG. 1 shows a compact loader 10 with battery features allowing a more efficient exchange of batteries is shown. The compact loader 10 comprises a prime battery 12 and an auxiliary battery 14. The prime battery 12 is responsible for all operations of the compact loader machine 10. The auxiliary battery 14 is powered by the prime battery 12 (and recharged by the prime battery when the auxiliary battery is low).

The auxiliary battery 14 (shown in phantom) is capable of operating the compact loader 10 in the “limp mode”. In “limp mode”, basic systems, like the tracks 22 and lift arms 24 may be operable at lower power. The auxiliary battery 14 is engaged to provide energy to drive members, such as tracks 22 and the loader arms 24, but may do so at a lower power, such that the compact loader 10 is not capable of work operation in “limp mode” but may operate enough to exchange the prime battery 12.

Further, the prime battery 12 may charge the auxiliary battery 14 when the prime battery is fully charged and the compact loader is operating in its normal mode. This reduces the likelihood of both of the prime battery 12 and auxiliary battery 14 being discharged at the same time.

The compact loader 10 has a system 50 for offloading an uncharged prime battery 12. This system 50 is capable of operation by the auxiliary battery 14 when in the “limp mode.” Various systems 50 may include shuttle arms, lift arm attachments, and crane attachments. These systems 50 are shown in greater detail herein. However, in any case, the frequent exchange of prime battery 12 assemblies will make the secure connection and easy disconnection of a prime battery 12 advantageous.

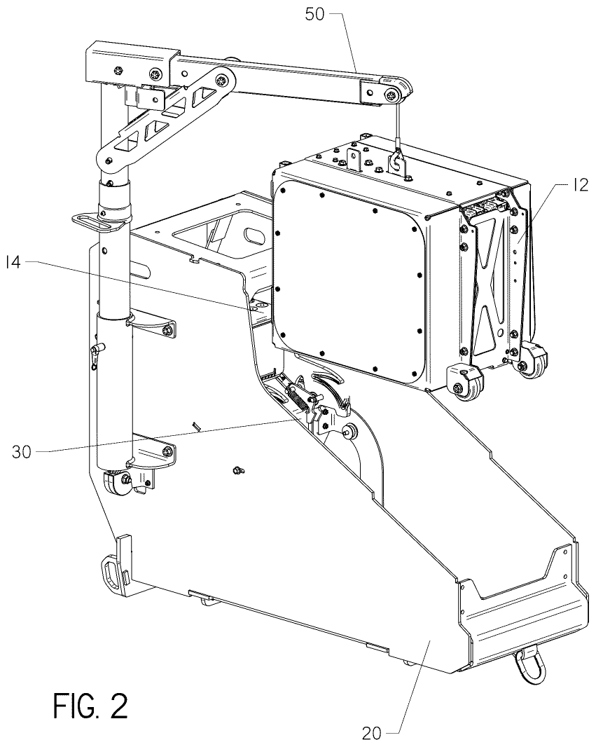

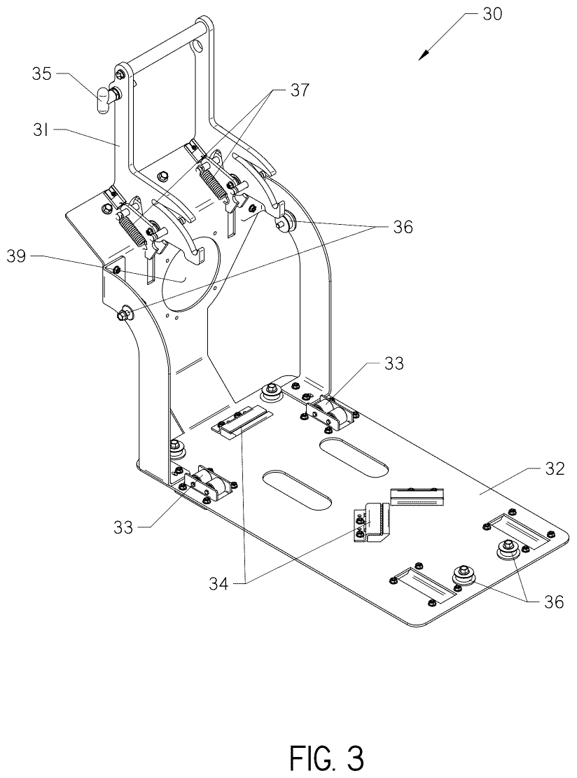

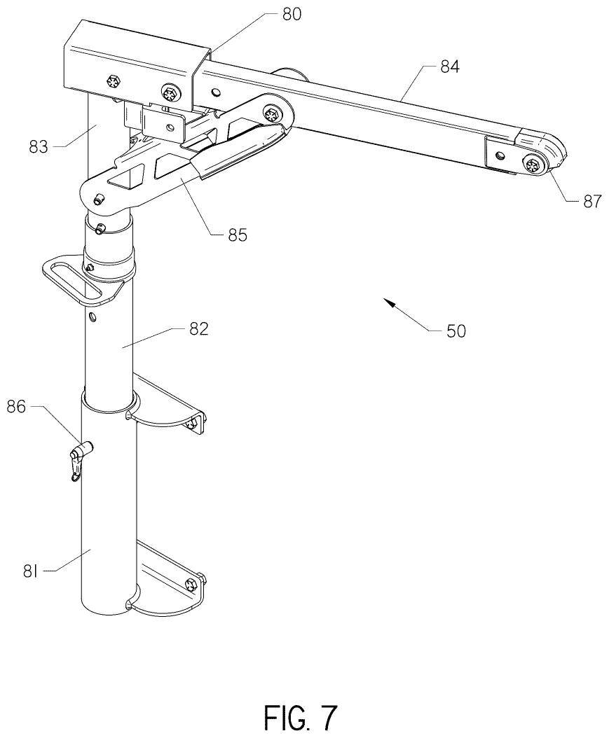

With reference to FIGS. 2-3, the compact loader 10 is shown with a loader frame 20 and a battery subframe 30. The loader frame 20 is shown without tracks or lift arms. The subframe 30 nests within the loader frame 20. While the subframe 30 is shown as a separate piece which is attached to the loader frame 20, it should be appreciated that the subframe 30 may be integrally formed with the frame 20 without departing from the spirit of the invention. Alternatively, the subframe 30 being a separate assembly may allow for the subframe to be exchanged within a compact loader 10 when different prime batteries 12 are used due to, for example, a different design associated with an upgraded future battery. In FIG. 2, the system 50 for removing the battery 12 is a crane 80, which is described in more detail with reference to FIG. 7.

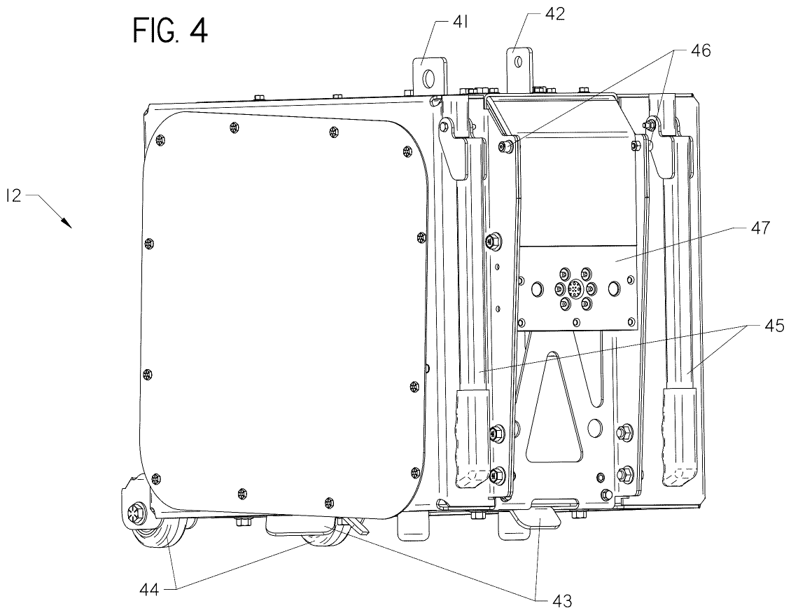

With reference to FIG. 3, the subframe 30 comprises a cammed lever 31, a subframe base plate 32, and rollers 33. Cleat hooks 34 are configured to attach to cleats 43 (FIG. 4) disposed on the bottom of the prime battery 12. A locking pin 35 is disposed on the cammed lever 31. Isolators 36 may provide electric isolation between the battery 12 and compact loader 10 by ensuring the battery 12 is correctly positioned, rather than improperly contacting the frame 20. The isolators primarily isolate vibration to limit compact loader 10 vibration from passing to the prime battery 12 and potentially causing damage.

The lever 31 includes over-center springs 37. As the battery 12 is lowered onto the subframe 30, it contacts hooks or tabs on the cammed lever 31. As the lever 31 is pulled or pushed downward, the open cam slots on the lever 31 engage the roller pins 46 on the prime battery 12 and pull the battery 12 into a connected position, over the rollers 33. The cammed lever 31 goes over-center as the open cam slots engage the roller pins 46 to assist in pulling and retaining the prime battery 12. When the lever 31 is fully rotated, the pin 35 may be attached to the battery, and the over-center arrangement of the lever holds the battery into place until the pin 35 is removed and the lever 31 is manually raised. Raising the lever 31 engages the pins 46 to push the prime battery 12 away from the connection point 70, breaking contact between the connector 47 and the connection point 70.

While the cammed lever 31 is shown, other mechanisms may be utilized to easily connect and disconnect the prime battery 12. A lever may be utilized to, for example, retract the retention cleats 43 or cleat hooks 34. The auxiliary battery 14 may automatically initiate a subroutine to move the prime battery 12 in position for removal from the subframe 30. While the cammed lever 31 is a preferred mechanism, as it enjoys simplicity and a mechanical advantage for both retaining and disconnecting the prime battery 12 from the loader 10, it is not to be understood as the exclusive means for retaining and disconnecting the prime battery.

Alternatively, the cams associated with the cammed lever 31 may be driven by the auxiliary battery 14, rather than by manual operation of the lever.

The subframe 30 includes a back aperture 39 through which a frame 20 connection point 70 may extend. While the subframe 30 is shown here with a system 50 for unloading the battery 12 including a crane, this subframe may be utilized with any of the varied systems suitable for operation in limp mode to remove a battery 12.

With reference to FIG. 4, an embodiment of the prime battery 12 is shown. The prime battery 12 has components to allow it to mate to the subframe 30. While the arrangement shown is advantageous, it should not be construed as being the only such arrangement which would allow easy coupling and uncoupling of a prime battery 12. The battery 12 comprises a lifting eyelet 41 and a latching pin eyelet 42. The lifting eyelet 41 is for use with a system 50 for offloading the battery 12, such as the crane shown in FIGS. 2 and 7. The latching pin eyelet 42 is configured to mate with the locking pin 35 to prevent the cammed lever 31 from coming unlatched.

The prime battery 12 comprises retention cleats 43 which, when in position, are mated with the cleat hooks 34. Wheels 44 allow the battery 12 to be rolled by an operator, for example, when handles 45 are extended such that the battery 12 can be wheeled along a ground surface from location to location for handling by the system 50.

Roller pins 46 on the back of the prime battery 12 engage with open cam slots on the cammed lever 31. When positioned properly, the prime battery 12 has a connector 47 located next to the connection point 70 of the loader 10.

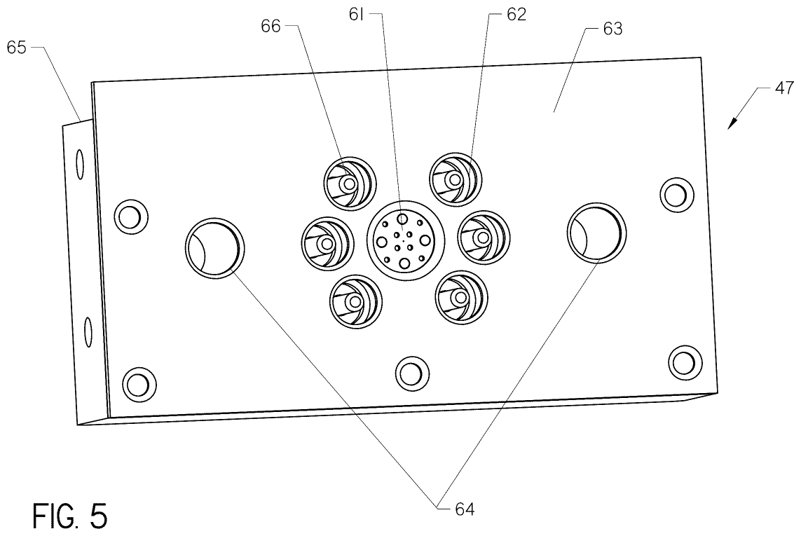

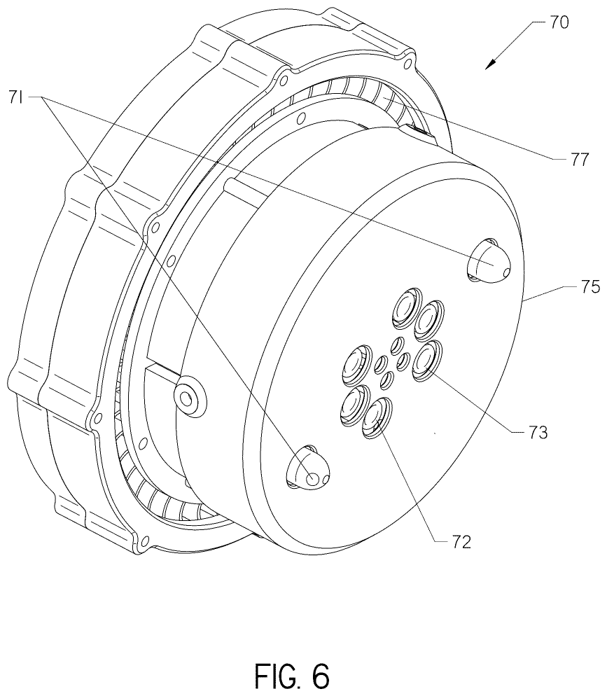

The connector 47 of the prime battery 12 is shown as a six pin connector. As shown, the connector 47 is the female side of a connection, while the connector 70 is the male side, and located on the frame 20. FIGS. 5 and 6 show this connection design.

The connector 47 has a central communication board 61 surrounded by a number of hyperboloid contacts 62 within bored holes, which allow electronic connection to a terminal block (not shown). Dowels 66 are located within each hole to prevent ingress of foreign materials or accidental contact with the operator. The communications board 61 enables the battery 12 management system to communicate with the loader 10. Two locating holes 64 help to position the connection point 70 against the battery 12. A housing 65 covers the connector 47, and the housing 65 has a front plate 63 which may be flush with the rest of the prime battery 12, to avoid damage.

As shown in FIG. 6, the connection point 70 on the frame 20 is a male connector. Pieces on the connection point 70 mate with the connector 47 when the battery 12 is in place. The connection point 70 comprises a positive terminal block 72 and a ground terminal block 73. These blocks 72, 73 communicate with the hyperboloid contacts 62 through pins 71 exposed when a spring loaded adjustable jacket 75 retracts upon contact with the battery 12, specifically the front face 63 of the connection point 47. Locating pins 71 are configured to find locating holes 64, allowing all contacts to match properly.

A compliant ring 77 is a rubber spring that allows the connection point 70 to receive the connector 47 despite rotational or translational offset that may or may not be present. The two terminal blocks 72, 73 may be solid milled blocks with hollow pins that match the contacts 62 of the connector 47. The moving adjustable jacket 75 protects the pins 71 from damage. Using spring under the jacket 75 protects the pins 71 from being hit by anything unless the jacket 75 is properly compressed by the battery 12.

The connection point 70 is mounted to the frame 20 and may extend through the back aperture 39.

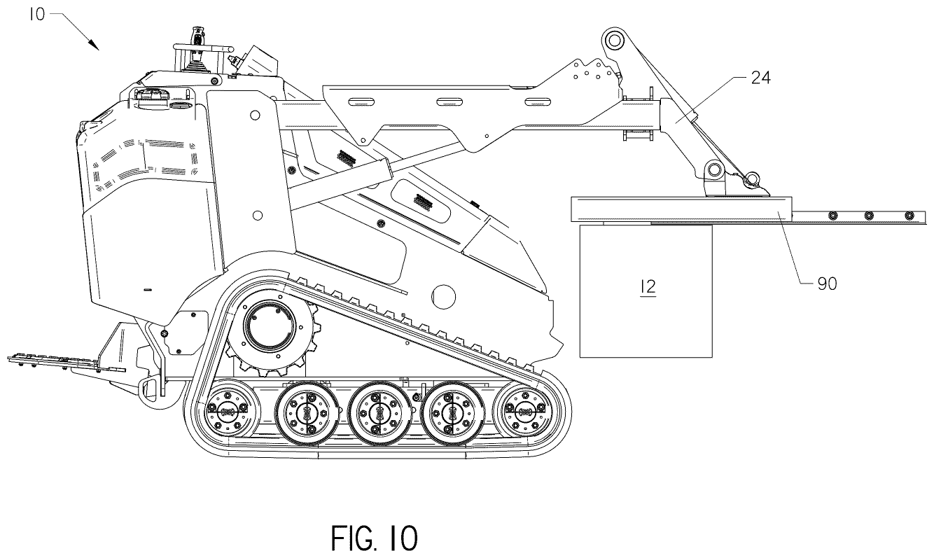

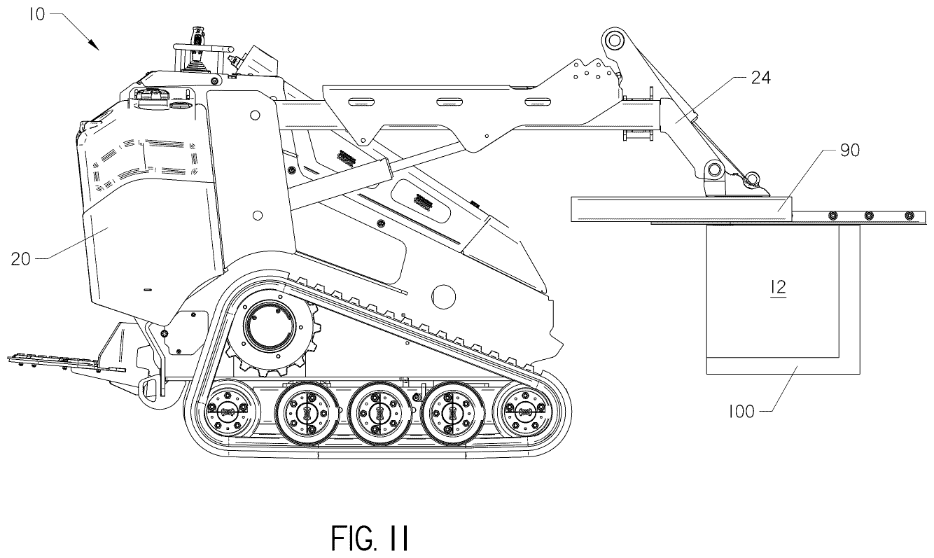

With reference to FIGS. 7-11, various systems 50 for offloading the prime battery 12 are shown. In FIG. 7, the system 50 is a crane 80. The crane 80 is bolted to the side of the frame 20 at a bracket. As shown the bracket is bolted to the frame 20 and a base tube 81. An intermediate tube 82 is disposed within the base tube 81, and a top tube 83 is disposed within the intermediate tube 82 and the top tube 83. All three tubes are connected by pins 86, which allow the various tubes 81, 82, 83 to lock in place. When not locked in place, the tubes 81, 82, 83 telescope. Air springs (not shown) or other powered actuators may deploy and retract the tubes 81, 82, 83. Alternatively, these may be deployed manually and locked by pins 86.

A brace 85 extends between the top tube 83 and a lift arm 84. The tubes 81-83 are configured to allow the lift arm 84 to swivel about a vertical axis, allowing a pulley 87 at the end of the lift arm 84 to be positioned advantageously above the prime battery 12, for example, above the lifting eyelet 41.

A cable (not shown) may run through a series of pulleys within the tubes and lift arm, extending over the final pulley 87 to allow lifting of the prime battery 12. A winch system (not shown) may be utilized with the cable, allowing it to be operated during “limp mode” through operation of the auxiliary battery 14. In addition, the various tubes 81-83 may swivel and extend manually, or by the actuation of pistons and/or motors powered by the auxiliary battery 14 when in “limp mode.” A worm gear (not shown) at the base of the base tube 81 may be powered by the auxiliary battery 14 and allow the crane 80 to swivel about a vertical axis such that the attached prime battery 12 may be removed from the frame 20 of the loader 10, and a new battery incorporated in its place.

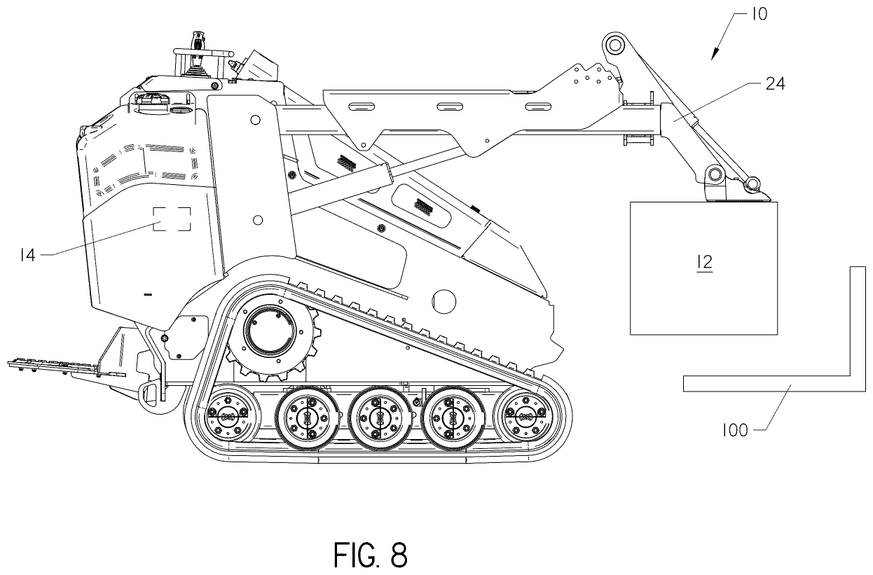

In FIG. 1, the loader 10 is equipped with a system 50 which comprises a set of slides 90. The lift arms 24 are equipped with a quick attach plate 91 which may engage with connection points on top of the prime battery 12. The prime battery 12 may be disconnected from the frame 20, and then carried by the slides 90 to a position in front of the frame 20 where the quick attach plate 91 can attach to the prime battery. The lift arms 24 pull the battery 12 off the slides, and then the prime battery 12 may be carried to a charger 100, as illustrated in FIG. 8. A fully charged replacement battery may be picked up using the quick attach plate 91 and reinstalled on the frame 20 of the loader 10.

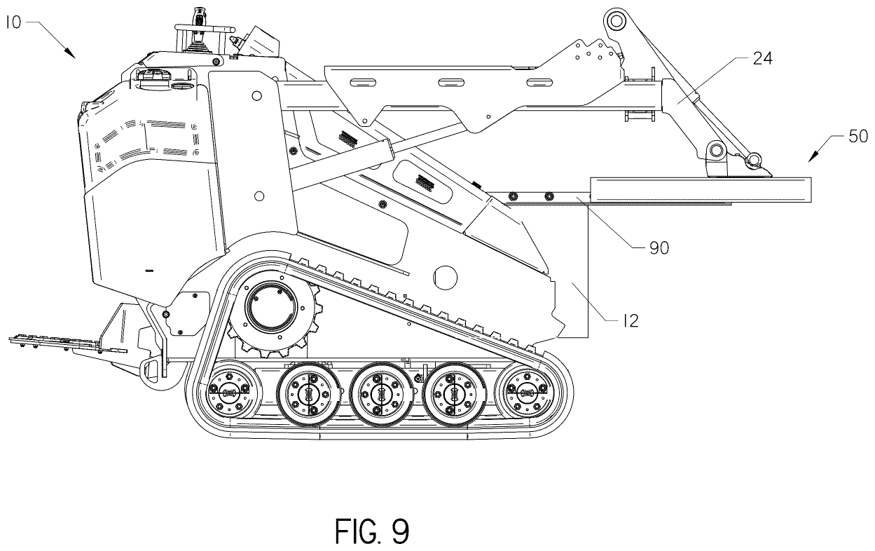

Alternatively, as shown in FIGS. 9-11, the slides 90 may be installed on the loader arm 24 itself. The slides 90 may have a location for attachment to the prime battery 12, such that the battery 12 can be moved away from the frame 20 for placement in a charger 100. The prime battery 12 may have a quick attach plate 91 disposed on it, so that the loader arms 24 may be used to lift the prime battery off the slides 90. After placement, the slides 90 may be retracted.

In the system of FIGS. 9-11, the prime battery 12 is disconnected from the frame. The battery 12 is disposed on the telescoping slides 90, which may allow the battery to move out of its position in the frame when discharged. Once sliding begins, any insertion blades connecting the machine and the battery are disconnected.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed.

For example, while this platform is disclosed with a skid steer machine, its platform can be used with other equipment such as horizontal directional drills, trenchers, plows, vac trailers, and mud mixers. The battery exchange technology would remain the same. The subframe, connector, battery pack and lifting mechanism would remain the same and be mounted within the existing frame of these systems.

1. A work machine, comprising:
a frame;
a ground engaging member providing mobility to the frame;
lift arms attached to the frame;
a first battery, supported by the frame, wherein the first battery provides power to the ground engaging member and the lift arms;
a second battery, supported by the frame, wherein the second battery provides power to the ground engaging member and the lift arms; and
a battery removal system, powered by the second battery, in which the battery removal system is configured to remove the first battery from the frame.

2. The work machine of claim 1 in which the battery removal system comprises a crane, the crane comprising:
a vertical section;
a horizontal section, suspended from the vertical section; and
a cable, supported by the horizontal section and configured to attach to the first battery.

3. The work machine of claim 2 in which the vertical section of the crane is telescoping.

4. The work machine of claim 2 in which the horizontal section is configured to rotate about a vertical axis, wherein the vertical axis is defined along a center of the vertical section.

5. The work machine of claim 4 in which the second battery powers rotation of the horizontal section about the vertical axis.

6. The work machine of claim 1 in which the battery removal system comprises a set of slides.

7. The work machine of claim 1 further comprising a subframe disposed within the frame, wherein the first battery is configured to attach to the subframe.

8. The work machine of claim 7 in which the subframe comprises a cammed lever, wherein the cammed lever is configured to interact with the first battery in a first position such that the first battery is locked in position relative to the frame, and wherein the cammed lever is configured to interact with the first battery in a second position such that the first battery is not locked relative to the frame.

9. A method for operating a battery-powered work machine, comprising:
with a first battery, powering operation of the work machine, wherein operation of the work machine includes movement of the work machine at a work site;
monitoring a power level of the first battery to determine if it is below a predetermined threshold;
when the power level is below the predetermined threshold, rotating a cammed lever on the frame to disconnect the first battery from the work machine;
thereafter, with a second battery:
moving the work machine to a battery charging location;
placing the first battery at the battery charging location; and
retrieving a fully-charged third battery; and
thereafter, connecting the third battery to the work machine.

10. The method of claim 9, wherein the second battery moves the work machine to the battery charging location at a power level lower than the power level at which the first battery moves the work machine at the work site.

11. The method of claim 9 wherein the step of placing the first battery at the battery charging location comprises:
using a crane, powered by the second battery and attached to the work machine, lifting the first battery;
rotating the crane to move the first battery away from the work machine; and
lowering the first battery to the battery charging location.

12. The method of claim 11 in which rotation of the crane is powered by the second battery.

13. The method of claim 9 wherein the step of placing the first battery at the battery charging location comprises:
operating a slide, powered by the second battery, to move the first battery away from the frame; and
with a lift arm, powered by the second battery, placing the first battery at the battery charging location.

14. The method of claim 13 in which the slide is attached to the lift arm.

15. The method of claim 13 in which the slide is operable such that the first battery is positioned for connection to the lift arm, and further comprising:
connecting the first battery to the lift arm.

16. The method of claim 9, further comprising:
thereafter, with the third battery, operating the work machine; and
charging the second battery with the third battery.

17. A method, comprising:
operating a work machine with a first battery in a high-power mode;
when a power level of the first battery reaches a predetermined level, operating the work machine with a second battery in a low-power mode;
with the second battery, operating the work machine to remove the first battery to a charging location.

18. The method of claim 17 further comprising:
thereafter, with the second battery, operating the work machine to connect a charged battery to the work machine.

19. The method of claim 18 in which the charged battery comprises a third battery.

20. The method of claim 17 wherein the step of operating the work machine to remove the first battery comprises:
moving a cammed lever to disconnect the first battery from the work machine;
connecting the first battery to a crane operated by the second battery;
with the crane, lifting the first battery; and
with the crane, lowering the first battery to the charging location.
